(19) United States
(12) Patent Application Publication
(10) Pub. No.: US 2008/0044730 A1
(43) Pub. Date: Feb. 21, 2008

(54) Alkaline battery

(76) Inventors: Ichiro Matsuhisa, Hyogo (JP); Susumu Kato, Osaka (JP); Yasushi Sumihiro, Hyogo (JP)

Correspondence Address: MCDERMOTT WILL & EMERY LLP, 600 13TH STREET, NW, WASHINGTON, DC, 20005-3096, US

(21) Appl. No.: 11/889,925

(22) Filed: Aug. 17, 2007

(30) Foreign Application Priority Data
Aug. 21, 2006 (JP) 2006-224393

(51) Int. Cl. H01M 4/66

(52) U.S. Cl. 429/223

(57) ABSTRACT

An alkaline battery includes a positive electrode case, a positive electrode material mixture including a hollow portion and contacting the inner side of the positive electrode case, a gelled negative electrode disposed in the hollow portion of the positive electrode material mixture, a separator disposed between the positive electrode material mixture and the gelled negative electrode, a resin sealing body for sealing the opening of the positive electrode case, and an alkaline electrolyte. The positive electrode material mixture includes manganese dioxide and nickel oxyhydroxide in a weight ratio of 20:80 to 80:20 as a positive electrode active material. The packing density of the positive electrode active material in the space encircled by the positive electrode case, the separator, and the sealing body is 2.65 to 3.00 g/cm³.

### FIELD OF THE INVENTION

The present invention relates to an alkaline battery using manganese dioxide and nickel oxyhydroxide for the positive electrode active material.

### BACKGROUND OF THE INVENTION

In alkaline batteries, a cylindrical positive electrode material mixture is disposed in a positive electrode case also functioning as a positive electrode terminal so that the mixture closely contact the positive electrode case, and in the center of the positive electrode material mixture, a gelled negative electrode is disposed with a separator interposed therebetween. Recently, with the load from electronic devices using such alkaline batteries as a power source increasing, batteries excellent in heavy-load discharge performance are desired. For improvement in the heavy-load discharge performance, use of nickel oxyhydroxide for the positive electrode active material has been examined.

For example, Japanese Laid-Open Patent Publication No. 2002-198060 has proposed a battery as described below. The positive electrode material mixture containing nickel oxyhydroxide is formed into a hollow cylindrical shape. In this positive electrode material mixture, a negative electrode is disposed with a separator interposed therebetween, to form an electrode body. This electrode body is housed in a bottomed cylindrical positive electrode case, and then the opening of the positive electrode case is sealed by disposing a sealing body. Then, considering the expansion of nickel oxyhydroxide contained in the positive electrode material mixture upon overdischarge, a gap corresponding to 5 to 10% of the positive electrode material mixture height is provided between the sealing body and the positive electrode material mixture.

However, even when such a gap is provided, when there is a large amount of active material in the positive electrode material mixture, the expansion of the positive electrode material mixture upon discharge may cause the positive electrode material mixture to lift the sealing body up and deform the sealing body, leading to a possibility of a leakage.

As a method for curbing the positive electrode material mixture expansion, for example, Japanese Laid-Open Patent Publication No. 2003-17078 has proposed that an expansion inhibiting member is provided in the positive electrode case between the positive electrode material mixture and the sealing body.

However, since the space for the active material to be charged in the positive electrode case decreases to the extent of the volume of the expansion inhibiting member to be disposed, it is difficult to improve discharge performance.

Thus, to solve the conventional problems as noted in the above, the present invention aims to provide an alkaline battery in which gas generation from overdischarge is curved, and leakage is excellently hindered without compromising discharge capacity.

### BRIEF SUMMARY OF THE INVENTION

An alkaline battery of the present invention includes:

a positive electrode case including an opening;

a positive electrode material mixture including a hollow portion and contacting the inner side of the positive electrode case;

a gelled negative electrode disposed in the hollow portion of the positive electrode material mixture;

a separator disposed between the positive electrode material mixture and the gelled negative electrode;

a resin sealing body for sealing the opening of the positive electrode case; and

an alkaline electrolyte,

wherein the positive electrode material mixture includes manganese dioxide and nickel oxyhydroxide in a weight ratio of 20:80 to 80:20 as a positive electrode active material, and

the packing density of the positive electrode active material in the space encircled by the positive electrode case, the separator, and the sealing body is 2.65 to 3.00 g/cm³.

The packing density is preferably 2.78 to 3.00 g/cm³.

The nickel oxyhydroxide is preferably B-nickel oxyhydroxide.

The sealing body preferably includes nylon 6,6 or nylon 6,12.

The present invention achieves providing an alkaline battery in which gas generation from overdischarge is curved, and leakage is excellently hindered without compromising discharge capacity.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a front view of an example of an alkaline battery of the present invention with a partially cutaway view.

FIG. 2 is a front view of a battery for evaluation with a partially cutaway view.

### DETAILED DESCRIPTION OF THE INVENTION

An alkaline battery of the present invention includes, a positive electrode case including an opening, a positive electrode material mixture including a hollow portion and contacting the inner side of the positive electrode case, a gelled negative electrode disposed in the hollow portion of the positive electrode material mixture, a separator disposed between the positive electrode material mixture and the gelled negative electrode, a resin sealing body for sealing the opening of the positive electrode case, and an alkaline electrolyte. The positive electrode material mixture includes manganese dioxide and nickel oxyhydroxide in a weight ratio of 20:80 to 80:20 as a positive electrode active material. The packing density of the positive electrode active material in the space encircled by the positive electrode case, the separator, and the sealing body is 2.65 to 3.00 g/cm³.

Thus, an alkaline battery in which leakage is excellently hindered can be obtained without compromising discharge capacity.

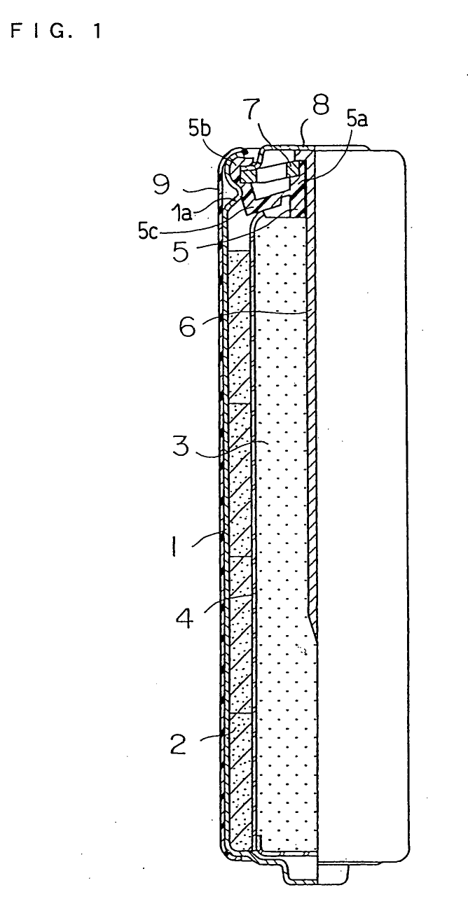

By referring to FIG. 1, one embodiment of the present invention is described. FIG. 1 is a front view of a cylindrical alkaline dry battery with a partially cutaway view.

A hollow cylindrical positive electrode material mixture 2 is disposed in a bottomed cylindrical positive electrode case 1 having the bottom functioning as a positive electrode terminal, so that the positive electrode material mixture 2 is brought in close contact with the inner side of the cylindrical positive electrode case 1. For the positive electrode case 1, for example, nickel-plated steel is used. The positive electrode material mixture 2 includes, for example, a mixture of the following: manganese dioxide and nickel oxyhydroxide mixture powder as an active material; graphite powder as a conductive material; and an alkaline electrolyte. For nickel oxyhydroxide, for example, B-nickel oxyhydroxide is used.

The average particle size of the manganese dioxide powder is, for example, 30 to 50 μm.

The average particle size of the nickel oxyhydroxide powder is, for example, 8 to 20 μm.

The average particle size of the graphite powder is, for example, 8 to 25 μm.

The weight ratio of the positive electrode active material to the conductive material to be mixed is, for example, 95:5 to 92.5:7.5.

Inside the hollow of the positive electrode material mixture 2, a bottomed cylindrical separator 4 is disposed. Inside the separator 4, a gelled negative electrode 3 is disposed. Further, inside the gelled negative electrode 3, a negative electrode current collector 6 is inserted. The gelled negative electrode 3 includes, for example, a mixture of a gelling agent such as sodium polyacrylate, an alkaline electrolyte, and a negative electrode active material. For the negative electrode active material, zinc powder or zinc alloy powder is used. For the zinc alloy, for example, a zinc alloy including Bi, In, and Al is used.

The average particle size of the zinc powder or the zinc alloy powder is, for example, 100 to 200 μm.

Used for the separator 4 is, for example, a nonwoven fabric made by a paper-making process using mainly polyvinyl alcohol fiber and rayon fiber. The positive electrode material mixture 2, the gelled negative electrode 3, and the separator 4 contain an alkaline electrolyte. For the alkaline electrolyte, for example, an aqueous solution of potassium hydroxide or an aqueous solution of sodium hydroxide is used.

The sealing body 5 includes, a center cylindrical portion 5a having a through hole for inserting the negative electrode current collector 6; an outer cylindrical portion 5b interposed between the peripheral portion of an insulating washer 7 and of a bottom plate 8, and the opening end of the positive electrode case 1; and a connecting portion 5c connecting the center cylindrical portion 5a and the outer cylindrical portion 5b. The sealing body 5 is integrated with the negative electrode current collector 6, a bottom plate 8 also functioning as a negative electrode terminal, and the insulating washer 7. The sealing body 5 may be obtained, for example, by injection molding nylon. For the sealing body 5, for example, nylon 6,6 or nylon 6,12 is used. Among these, nylon 6,12 excellent in alkali-resistance is preferably used for the sealing body 5.

A notch 1a is provided in the proximity of the lower portion of the opening of the positive electrode case 1, and at the upper portion of the notch 1a, the opening end of the positive electrode case is bent so as to cover the upper portion of the outer cylindrical portion of the sealing body 5, and the bent portion is crimped inwardly so as to fasten the peripheral portion of the bottom plate 8 along with the insulating washer 7. The opening of the positive electrode case 1 is thus sealed by the sealing body 5.

In the above embodiment, the weight ratio of manganese dioxide to nickel oxyhydroxide to be mixed as the positive electrode active material in the positive electrode material mixture is 20:80 to 80:20. When the nickel oxyhydroxide content in the positive electrode material mixture exceeds 80 parts by weight per 100 parts by weight of the positive electrode active material (the total of manganese dioxide and nickel oxyhydroxide), the amount of nickel oxyhydroxide having a large volume-expansion rate becomes large in the positive electrode material mixture to increase the expansion rate of the positive electrode material mixture, easily causing leakage upon overdischarge. On the other hand, when the nickel oxyhydroxide content in the positive electrode material mixture is below 20 parts by weight per 100 parts by weight of the positive electrode active material (the total of manganese dioxide and nickel oxyhydroxide), the amount of nickel oxyhydroxide in the positive electrode material mixture decreases, declining heavy-load discharge performance.

The packing density of the positive electrode active material (manganese dioxide and nickel oxyhydroxide) in the space encircled by the positive electrode case 1, the separator 4, and the sealing body 5 (hereinafter referred to as space A) is 2.65 to 3.00 g/cm³. When the packing density of the positive electrode active material in space A is below 2.65 g/cm³, the amount of the positive electrode active material decreases, declining discharge performance. When the packing density of the positive electrode active material in space A exceeds 3.00 g/cm³, the amount of the positive electrode active material becomes large to increase the expansion rate of the positive electrode material mixture upon discharge, and the sealing body is pushed up outwardly from the positive electrode material mixture expansion, easily causing leakage upon overdischarge.

The above embodiment achieves providing an alkaline battery in which gas generation from overdischarge is curved, and leakage is excellently hindered without compromising discharge capacity.

Further, the packing density of the positive electrode active material in space A is preferably 2.78 to 3.00 g/cm³, since discharge performance and leakage resistance further improve based on excellent adherence of the active material powder to the graphite powder and the optimized amount of the active material charged.

The packing density of the positive electrode active material in space A is obtained by using the following formula (1).

P1=Q/R1 (1)

In the formula (1), P1 represents the packing density (g/cm³) of the positive electrode active material in space A, Q represents the amount of the positive electrode active material in the positive electrode material mixture (g), and R1 represents the volume of space A (cm³).

The volume of space A can be obtained, for example, by comprehending the condition inside the battery by an X-ray film of the alkaline battery.

The packing density of the positive electrode active material in the positive electrode material mixture is preferably 2.91 to 3.21 g/cm³.

The packing density of the positive electrode active material in the positive electrode material mixture can be obtained by the following formula (2).

P2=Q/R2 (2)

In the formula (2), P2 represents the packing density of the positive electrode active material in the positive electrode material mixture (g/cm³), Q represents the amount of the positive electrode active material in the positive electrode material mixture (g), and R2 represents the volume of the positive electrode material mixture (cm³).

Examples of the present invention are described in detail in the following, but the present invention is not limited to these Examples.

### EXAMPLES 1 TO 3 AND 6, AND COMPARATIVE EXAMPLES 2, 3, AND 6

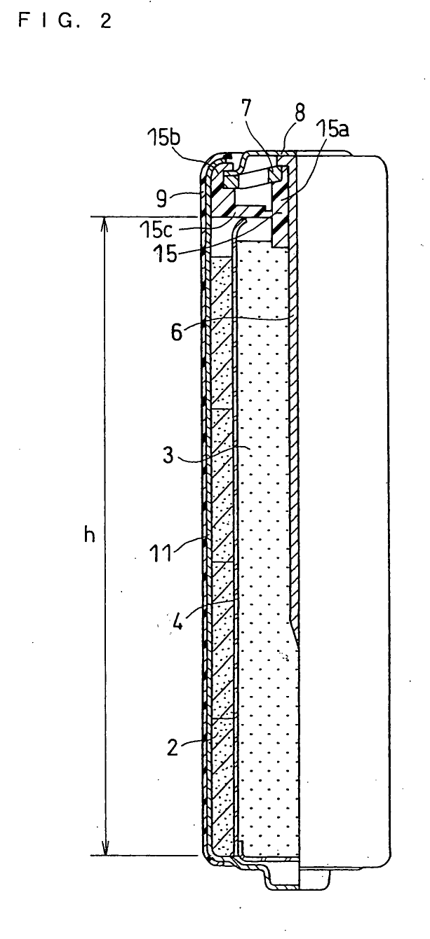

An AA alkaline dry battery as shown in FIG. 2 was made. The battery shown in FIG. 2 was structured in the same manner as the battery in FIG. 1 as mentioned above, except that a sealing body 15 was used instead of the sealing body 5, and a positive electrode case 11 was used instead of the positive electrode case 1 for easily and accurately determining the packing density of the positive electrode active material in the space encircled by the positive electrode case, the separator, and the sealing body. That is, the sealing body 15 used had a flat face on the side thereof facing the positive electrode material mixture 2 (the lower side of an outer cylindrical portion 15b and a connecting portion 15c), the flat face being perpendicular to the side face of the positive electrode case 11. Unlike the positive electrode case 1, the positive electrode case 11 had no notch 1a.

The alkaline dry battery of FIG. 2 was made as in below.

Manganese dioxide powder (average particle size: 35 μm), B-nickel oxyhydroxide powder (average particle size: 11 μm), and graphite powder (average particle size: 12 μm) were mixed in a weight ratio of 47:47:6. Further, to the obtained mixture, 1.5 parts by weight of an alkaline electrolyte in 100 parts by weight of the mixture was added and stirred sufficiently, and then the mixture was molded by compression to be formed into flakes. Then, the positive electrode material mixture flakes were ground to be formed into granules, and the granules were sieved for classification. The granules with 10 to 100 mesh were pressure-molded to be formed into a hollow cylindrical shape, thereby obtaining a positive electrode material mixture pellet.

A plurality of the above positive electrode material mixture pellets were inserted into the positive electrode case 11 (inner diameter: 13.44 mm) and re-molded by a compression jig to obtain a hollow cylindrical positive electrode material mixture 2 (inner diameter: 9.0 mm) with a predetermined height. The positive electrode material mixture 2 was brought into close contact with the inner wall of the positive electrode case 11.

Then, the separator 4 was disposed at the side face and the bottom face of the hollow portion of the positive electrode material mixture 2 placed in the positive electrode case 11, and inside the separator 4, a predetermined amount of the alkaline electrolyte was injected. The electrolyte was absorbed into the positive electrode material mixture 2 through the separator 4. After a predetermined time passed, a gelled negative electrode 3 was injected in the hollow portion of the positive electrode material mixture 2 with the separator 4 interposed therebetween.

Used for the gelled negative electrode 3 was a gelled negative electrode including 1 part by weight of sodium polyacrylate as a gelling agent, 33 parts by weight of the alkaline electrolyte, and 66 parts by weight of a negative electrode active material. For the negative electrode active material, zinc alloy powder including 35 ppm of Al, 250 ppm of Bi, and 500 ppm of In was used. Used for the separator 4 was a nonwoven fabric made by a paper-making process using mainly polyvinyl alcohol fiber and rayon fiber. For the alkaline electrolyte, an aqueous solution of 40 wt % sodium hydroxide was used.

Then, the negative electrode current collector 6 was inserted into the gelled negative electrode 3. The negative electrode current collector 6 was integrated in advance with the sealing body 15, the bottom plate 8 also functioning as the negative electrode terminal, and the insulating washer 7. The sealing body 15 was obtained by injection molding nylon 6,6. Then, the opening end of the positive electrode case 11 was crimped to the peripheral portion of the bottom plate 8 along with the insulating washer 7 with the sealing body 15 interposed therebetween, to seal the opening of the positive electrode case 11. Then, the outer surface of the positive electrode case was covered with an outer jacket, thereby obtaining an alkaline battery. The height from the face of the positive electrode case 11 at the bottom thereof contacting the positive electrode material mixture 2 to the face of the sealing body 15 on the side thereof facing the positive electrode material mixture (h in FIG. 2) was 43 mm.

Upon making the above alkaline battery, the amount of the positive electrode active material to be charged in the positive electrode case 11, that is, the total amount of manganese dioxide and nickel oxyhydroxide was changed variously as shown in Table 1. The mixing weight ratio of manganese dioxide and nickel oxyhydroxide was set to a constant value as shown in Table 1.

### COMPARATIVE EXAMPLE 1

An alkaline battery was made in the same manner as Example 1, except that only manganese dioxide was used as the positive electrode active material, and the mixing weight ratio of manganese dioxide and graphite in the positive electrode material mixture, and the amount of the positive electrode active material were set to the values as shown in Table 1.

### EXAMPLES 4 AND 5, AND COMPARATIVE EXAMPLES 4 AND 5

An alkaline battery was made in the same manner as Example 1, except that the mixing weight ratio of manganese dioxide and nickel oxyhydroxide was set to the values as shown in Table 1. The amount of the positive electrode active material to be charged in the positive electrode case 11, that is, the total amount of manganese dioxide and nickel oxyhydroxide was set to a constant value as shown in Table 1.

### EXAMPLES 7 AND 8

An alkaline battery was made in the same manner as Example 1, except that the mixing weight ratio of manganese dioxide, nickel oxyhydroxide, and graphite, and the amount of the positive electrode active material were set to the values as shown in Table 1.

### COMPARATIVE EXAMPLE 7

An alkaline battery was made in the same manner as Example 8, except that the amount of the positive electrode active material was set to the value as shown in Table 1.

### EXAMPLE 9

An alkaline battery was made in the same manner as Example 1, except that for the material of the sealing body 15, nylon 6,12 was used instead of nylon 6,6.

TABLE 1

| | | | | | Positive | |
|---|---|---|---|---|---|---|
| | | | | | Electrode | |
| | | | | | Active | |
| | | | | | Material | |
| | | | | | Amount | |
| | | | | Positive | in | Positive |
| | Mixing Weight Ratio of Positive | | | Electrode | Positive | Electrode |
| | Electrode Material Mixture | | | Material | Electrode | Material |
| | Materials (wt %) | | | Mixture | Material | Mixture |
| | Nickel | Manganese | | Amount | Mixture | Height |
| | Oxyhydroxide | Dioxide | Graphite | (g) | (g) | (mm) |
| Comp. | 0 | 94 | 6 | 10.74 | 10.10 | 42.40 |
| Ex. 1 | | | | | | |
| Comp. | 47 | 47 | 6 | 9.29 | 8.73 | 38.40 |
| Ex. 2 | | | | | | |
| Ex. 1 | 47 | 47 | 6 | 9.51 | 8.94 | 39.20 |
| Ex. 2 | 47 | 47 | 6 | 9.96 | 9.36 | 41.00 |
| Ex. 3 | 47 | 47 | 6 | 10.74 | 10.10 | 43.00 |
| Comp. | 47 | 47 | 6 | 10.91 | 10.26 | 43.00 |
| Ex. 3 | | | | | | |
| Comp. | 4.7 | 89.3 | 6 | 10.74 | 10.10 | 42.50 |
| Ex. 4 | | | | | | |
| Ex. 4 | 18.8 | 75.2 | 6 | 10.74 | 10.10 | 42.65 |
| Ex. 5 | 75.2 | 18.8 | 6 | 10.74 | 10.10 | 43.00 |
| Comp. | 89.3 | 4.7 | 6 | 10.74 | 10.10 | 43.00 |
| Ex. 5 | | | | | | |
| Ex. 6 | 47 | 47 | 6 | 10.74 | 10.10 | 41.50 |
| Comp. | 47 | 47 | 6 | 10.97 | 10.31 | 41.50 |
| Ex. 6 | | | | | | |
| Ex. 7 | 46.25 | 46.25 | 7.5 | 10.90 | 10.08 | 43.00 |
| Ex. 8 | 47.5 | 47.5 | 5 | 10.60 | 10.07 | 43.00 |
| Comp. | 47.5 | 47.5 | 6 | 10.80 | 10.26 | 40.90 |
| Ex. 7 | | | | | | |
| Ex. 9 | 47 | 47 | 6 | 10.74 | 10.10 | 43.00 |

The packing density of the positive electrode active material in the positive electrode material mixture in Table 2 was obtained by using the above formula (2). That is, the value was the amount of the positive electrode active material in Table 1 divided by the volume of the positive electrode material mixture. The volume of the positive electrode material mixture was obtained from the height of the positive electrode material mixture in Table 1, the inner diameter of the positive electrode material mixture (9 mm), and the inner diameter of the positive electrode case 11 (13.44 mm).

The packing density of the positive electrode active material in space A encircled by the positive electrode case 11, the separator 4, and the sealing body 15 in Table 2 was obtained by using the above formula (1). That is, the value was the amount of the positive electrode active material in Table 1 divided by the volume of space A. The volume of space A was obtained from value h in FIG. 2 (43 mm), the inner diameter of the positive electrode material mixture 2 (9 mm), and the inner diameter of the positive electrode case 11 (13.44 mm).

TABLE 2

| | Positive | | | |
|---|---|---|---|---|
| | Electrode | | | |
| | Active | Positive | | |
| | Material | Electrode | | |
| | Packing | Active | | |
| | Density | Material | | |
| | In Positive | Packing | | |
| | Electrode | Density | Number of | |
| | Material | In | Batteries in | Discharge |
| | Mixture | Space A | which Leakage | Performance |
| | (g/cm³) | (g/cm³) | Occurred | Index |
| Comp. | 3.04 | 3.00 | 0 | 100 |
| Ex. 1 | | | | |
| Comp. | 2.91 | 2.59 | 0 | 98 |
| Ex. 2 | | | | |
| Ex. 1 | 2.91 | 2.65 | 0 | 119 |
| Ex. 2 | 2.92 | 2.78 | 0 | 124 |
| Ex. 3 | 3.00 | 3.00 | 0 | 135 |
| Comp. | 3.05 | 3.04 | 5 | 140 |
| Ex. 3 | | | | |
| Comp. | 3.04 | 3.00 | 0 | 102 |
| Ex. 4 | | | | |
| Ex. 4 | 3.02 | 3.00 | 0 | 132 |
| Ex. 5 | 3.00 | 3.00 | 0 | 135 |
| Comp. | 3.00 | 3.00 | 2 | 135 |
| Ex. 5 | | | | |
| Ex. 6 | 3.11 | 3.00 | 0 | 124 |
| Comp. | 3.18 | 3.06 | 3 | 130 |
| Ex. 6 | | | | |
| Ex. 7 | 3.00 | 2.99 | 0 | 135 |
| Ex. 8 | 2.99 | 2.99 | 0 | 134 |
| Comp. | 3.21 | 3.05 | 3 | 134 |
| Ex. 7 | | | | |
| Ex. 9 | 3.00 | 3.00 | 0 | 135 |

### [Battery Evaluation]

### (1) Discharge Performance Evaluation

A pulse discharge was carried out for each battery, by alternating a 3 second discharge with a constant electric power of 1000 mW and a 10 second pause until the closed circuit voltage reached 0.9 V under the 20° C. environment. Then the discharge time was obtained. Table 2 shows the results. The discharge performance in Table 2 is shown as an index where the discharge time of the battery in Comparative Example 1 is set as 100. Batteries are determined as excellent in discharge performance, when the discharge time is greater by 10% or more than the discharge time of the battery of Comparative Example 1, that is, when the discharge performance index is 110 or more.

### (2) Leakage-Resistance Evaluation

In each Example, 10 batteries were prepared, and those 10 batteries were connected in series along with a 20 O resistance to be discharged continuously for one week under a constant temperature environment. The batteries after the 1-week discharge were checked if there was any leakage.

The above evaluation results are shown in Table 2.

No leakage was found in any of the batteries in Examples 1 to 3, in which the active material packing density in space A was 3 g/cm³ or less.

In the battery of Comparative Example 2, in which the active material packing density in space A was 2.59 g/cm³, the height of the positive electrode material mixture was low and its area of the portion facing the gelled negative electrode was small; therefore, the discharge performance declined more than that of the battery in Comparative Example 1, in which only manganese dioxide was used for the positive electrode active material. On the other hand, in the battery of Comparative Example 3, in which the active material packing density in space A was 3.04 g/cm³, due to the positive electrode active material expansion, the positive electrode material mixture could not fit in space A and caused a sealing body distortion; therefore, leakage was found in the battery.

The batteries of Examples 4 and 5, in which the mixing weight ratios of nickel oxyhydroxide to manganese dioxide were 20:80 and 80:20, respectively, achieved excellent discharge performance and leakage resistance.

However, although excellent discharge performance was achieved in the batteries of Comparative Example 5, in which the proportion of nickel oxyhydroxide was large, leakage occurred in the batteries, due to the volume expansion upon discharge and the pushing up of the positive electrode material mixture to cause distortion in the sealing body. On the other hand, although the batteries of Comparative Example 4 with a large proportion of manganese dioxide achieved excellent leakage resistance, its discharge performance was the same level with the batteries of Comparative Example 1.

Excellent leakage resistance was achieved by the batteries of Example 6, in which the amount of the positive electrode active material was the same as that of the batteries of Example 3 but the packing density of the active material in the positive electrode material mixture was made higher than that of the batteries of Example 3 to lower the height of the positive electrode material mixture. However, the volume expansion of the positive electrode material mixture upon discharge increased and leakage occurred in the batteries of Comparative Example 6, in which the height of the positive electrode material mixture was the same as that of the batteries of Example 6 and the positive electrode material mixture weight was increased so that the active material packing density was 3.06 g/cm³, because of the large amount of the charged positive electrode active material despite the low height of the positive electrode material mixture.

Excellent discharge performance and leakage resistance were achieved by the batteries of Examples 7 and 8, in which the amount of the positive electrode active material was the same as that of the batteries of Example 3 and the amount of graphite was changed.

Leakage occurred in the batteries of Comparative Example 7, in which the positive electrode active material packing density in space A was 3.05 g/cm³, setting the mixing weight ratio in the positive electrode material mixture to the same as that of the batteries of Example 8; the positive electrode material mixture weight to larger than that of the batteries of Example 8; and the height of the positive electrode material mixture to lower than that of the batteries of Example 8.

An alkaline battery of the present invention achieves excellent discharge performance and leakage resistance, thus is suitably used for a power source for electronic devices such as communication devices and portable devices.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. An alkaline battery comprising:
a positive electrode case including an opening;
a positive electrode material mixture including a hollow portion and contacting an inner side of said positive electrode case;
a gelled negative electrode disposed in said hollow portion of said positive electrode material mixture;
a separator disposed between said positive electrode material mixture and said gelled negative electrode;
a resin sealing body for sealing said opening of said positive electrode case; and
an alkaline electrolyte,
wherein said positive electrode material mixture includes manganese dioxide and nickel oxyhydroxide in a weight ratio of 20:80 to 80:20 as a positive electrode active material, and
a packing density of said positive electrode active material in a space encircled by said positive electrode case, said separator, and said sealing body is 2.65 to 3.00 g/cm³.

2. The alkaline battery in accordance with claim 1, wherein said packing density is 2.78 to 3.00 g/cm³.

3. The alkaline battery in accordance with claim 1, wherein said nickel oxyhydroxide is B-nickel oxyhydroxide.

4. The alkaline battery in accordance with claim 1, wherein said sealing body comprises nylon 6,6 or nylon 6,12.
